(19) United States
(12) Patent Application Publication
(10) Pub. No.: US 2016/0097011 A1
(43) Pub. Date: Apr. 7, 2016

(54) HOUSING FOR A GAS PROCESSING APPARATUS

(71) Applicant: PRIDE OF THE HILLS MANUFACTURING, INC., Big Prairie, OH (US)

(72) Inventors: Curtis W. Murray, SR., Big Prairie, OH (US); Curtis W. Murray, JR., Wooster, OH (US); Leroy P. Whited, Elyria, OH (US); Dustin Baker, Shreve, OH (US)

(21) Appl. No.: 14/873,689

(22) Filed: Oct. 2, 2015

Related U.S. Application Data
(60) Provisional application No. 62/060,918, filed on Oct. 7, 2014.

(51) Int. Cl. C10L 3/00; E04H 1/12; A47B 81/00; B01D 50/00; C10L 3/10

(52) U.S. Cl. CPC C10L 3/00; B01D 50/00; C10L 3/101; A47B 81/00; E04H 1/12; C10L 2290/567; C10L 2290/54; C10L 2290/58; E04H 2001/1283

(57) ABSTRACT

The present invention provides a housing for a gas processing apparatus formed by a plurality of walls joined together to form a box-like structure defining a chamber therein. The chamber is configured to retain a pair or more of gas processing pressure vessels in a vertically stacked configuration. The housing has a width less the United States Department of Transportation Federal Highway Administration maximum width for a commercial vehicle to allow transportation of the housing without the need for an oversized load shipping permit. The floor width inside the chamber less than a width for said pair of pressure vessels if said vessels were in a side-by-side configuration.

### CROSS REFERENCE TO RELATED APPLICATION

This application claims the benefit of U.S. Provisional Application Ser. No. 62/060,918, filed Oct. 7, 2014; the disclosure of which is entirely incorporated herein by reference.

### BACKGROUND OF THE INVENTION

1. Technical Field

The present invention relates generally equipment used in the field of fossil fuel processing. More particularly, the present invention relates to a housing for retaining pressure vessels in a gas processing system. Specifically, the present invention relates to a housing for a gas processing apparatus including a chamber for retaining pressure vessels in a vertically stacked configuration and a housing width narrower than the United States Department of Transportation Federal Highway Administration maximum width for a commercial vehicle to allow transportation of the housing without the need for an oversized load shipping permit.

2. Background Information

Fossil fuel exploration and drilling is a booming industry that often requires extracting operations to occur in remote areas. The remoteness of some well sites increases the difficulty for transporting drilling components and processing units as the roadway infrastructure may not be fully developed to handle such an aggressive construction timeline for extracting the fossil fuels. Some gas processing systems require two separators to cooperate together in separating fuel from non-fuel, particulates, and other liquids as natural gas or fossil fuels are extracted from the ground.

To date, these two separator systems are aligned in a side-by-side basis that require a housing to be quite wide. These wide housings are very often wider than the federal highway maximum width for transporting goods on a highway. As such, suppliers of these vessels must obtain a special wide load permit to ship these two side-by-side separators.

### SUMMARY

Issues continue to exist with dual separators arranged in a side-by-side configuration. The present invention addresses these and other issues by providing a gas processing housing box able to retain two gas processing pressure vessels therein while maintaining a width narrower than the United States Department of Transportation Federal Highway Administration maximum width for a commercial vehicle.

In one aspect, an embodiment of the invention may provide a transportable housing for a gas processing apparatus comprising: a chamber defined by a plurality of housing walls joined together to therein retain at least two gas processing pressure vessels in a vertically stacked configuration; and a housing width narrower than the United States Department of Transportation Federal Highway Administration maximum width for a commercial vehicle to allow transportation of the housing without the need for an oversized load shipping permit.

In one aspect, an embodiment of the invention may provide a housing for two vertically stacked fuel separators comprising: a first sidewall on a housing box therein defining a chamber; a second sidewall on the housing box spaced apart from the first sidewall; a housing width distance, defined from the first sidewall to the second sidewall, less than about 102 inches; the chamber adapted to therein contain two vertically stacked gas processing separators and a gas processing heater; and a heat exchanging container within the chamber.

In another aspect, the invention may provide a gas processing apparatus housing comprising: a floor having a width; a housing chamber defined by the floor and connected walls, the chamber adapted to retain a pair of gas processing pressure vessels in a vertically stacked configuration; and the floor width less than a width for the pair of pressure vessels if the vessels were in a side-by-side configuration.

In yet another aspect, an embodiment may provide a method of constructing a housing for a stacked gas processing apparatus, comprising the steps of: forming a housing first section to retain a stacked gas processing apparatus therein; connecting the housing first section to a housing second section to form a box-like structure and having a housing width narrower than the United States Department of Transportation Federal Highway Administration maximum width for a commercial vehicle to permit transportation of the housing without the need for an oversized load shipping permit.

In another aspect, an embodiment may provide a method of use for two gas processing pressure vessels comprising the steps of: mounting two gas processing pressure vessels in a stacked configuration within a chamber of a gas processing housing; and attaching a wall to the housing to enclose the chamber, wherein the housing includes a housing width narrower than the United States Department of Transportation Federal Highway Administration maximum width for a commercial vehicle to allow transportation of the housing without the need for an oversized load shipping permit. Then, further comprising the step of transporting the housing on a road without an oversized load shipping permit.

In another aspect, the invention may provide a housing for a gas processing apparatus formed by a plurality of walls joined together to form a box-like structure defining a chamber therein. The chamber is configured to retain a pair or more of gas processing pressure vessels in a vertically stacked configuration. The housing has a width less the United States Department of Transportation Federal Highway Administration maximum width for a commercial vehicle to allow transportation of the housing without the need for an oversized load shipping permit. The floor width inside the chamber less than a width for said pair of pressure vessels if said vessels were in a side-by-side configuration.

### BRIEF DESCRIPTION OF THE SEVERAL VIEWS OF THE DRAWINGS

A sample embodiment of the invention, illustrative of the best mode in which Applicant contemplates applying the principles, is set forth in the following description, is shown in the drawings and is particularly and distinctly pointed out and set forth in the appended claims. The accompanying drawings, which are incorporated in and constitute a part of the specification, illustrate various example methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1A is an assembled perspective view of a housing for a gas processing apparatus;

FIG. 1B is a perspective view of the housing in a separated state and depicting that two sections are joined together to form the assembled housing;

FIG. 2 is a left side elevation view of the housing;

FIG. 3 is an end elevation view of the housing;

FIG. 4 is a top section view taken along line 4-4 in FIG. 2;

FIG. 5 is a side section view taken along line 5-5 in FIG. 3;

FIG. 6 is an end section view taken along line 6-6 in FIG. 2;

FIG. 7 is an environmental left side view of the housing on a trailer towed by a tractor-truck for shipment; and

FIG. 8 is an end section view taken along line 8-8 in FIG. 7 depicting the housing on the trailer having a width less than the federal maximum for a commercial vehicle.

Similar numbers refer to similar parts throughout the drawings.

### DETAILED DESCRIPTION

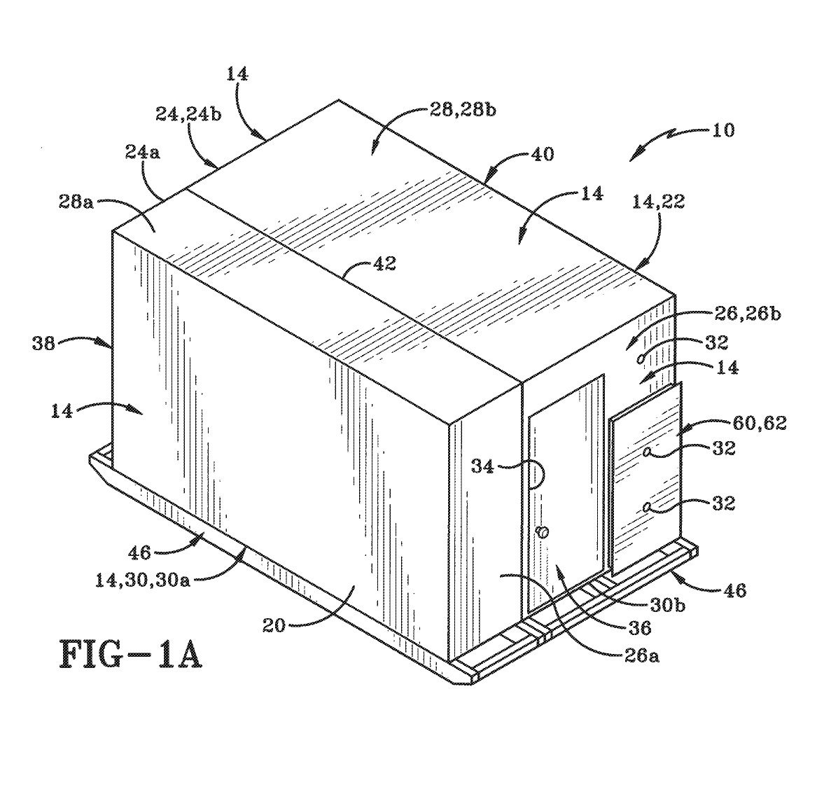

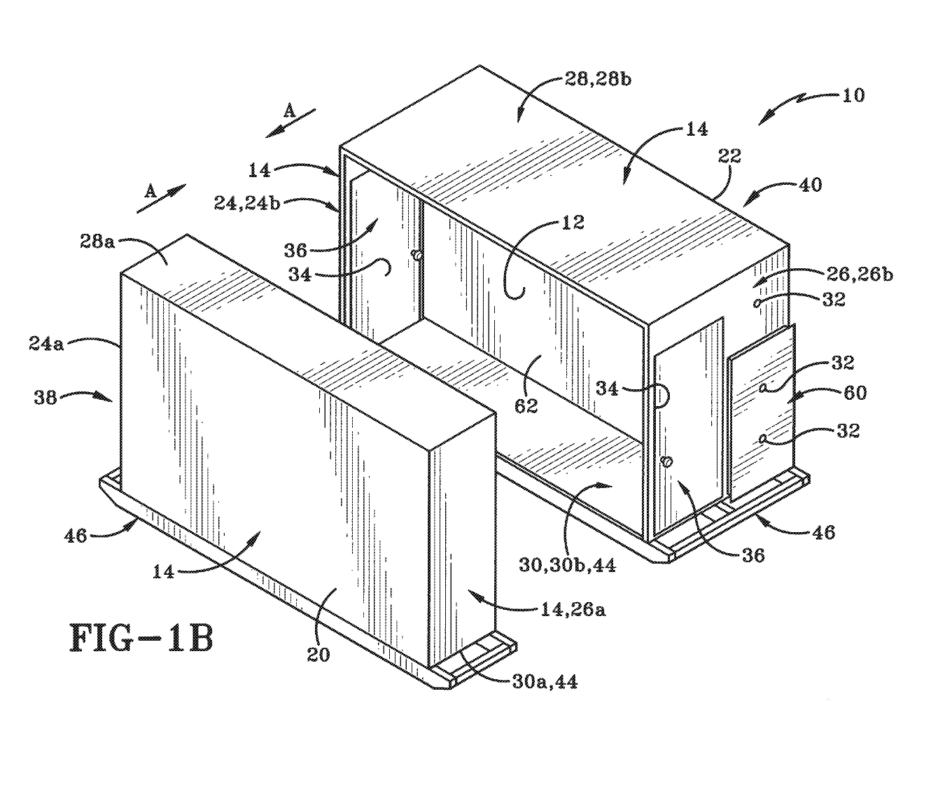

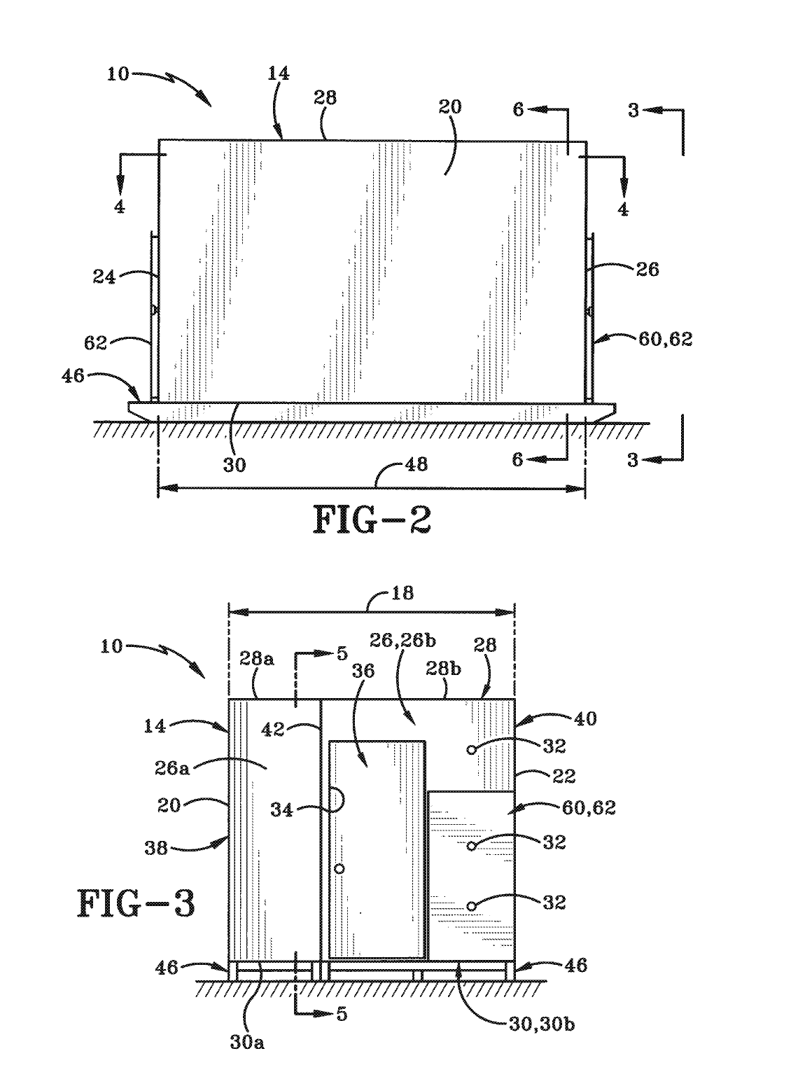

The new housing for a gas processing apparatus of the present invention depicted throughout FIGS. 1-8 is shown generally as 10. Housing 10 is an improved device including a chamber 12 (FIG. 1B) defined by a plurality of housing walls 14 joined together to therein retain at least two gas processing pressure vessels 16 in a vertically stacked configuration. Housing 10 includes a housing width 18 (FIG. 3) narrower than the United States Department of Transportation Federal Highway Administration maximum width for a commercial vehicle to permit transportation (i.e., shipment) of the housing without the need for an oversized load shipping permit.

As detailed in FIG. 1A and FIG. 1B, housing 10 includes a left wall 20 spaced apart from a right wall 22 that therebetween define a lateral direction. Housing 10 further includes a first end wall 24 spaced apart from a second end wall 26 that therebetween define a longitudinal direction. Housing 10 further includes a top wall 28 spaced apart and opposite a bottom wall 30 therebetween defining a vertical direction. Walls 20, 22, 24, 26, 28, and 30 are joined together to form a general box-like structure therein defining chamber 12.

With continued reference to FIG. 1A and FIG. 1B, a plurality of apertures 32 may be formed in the walls permitting gas pipeline to flow therethrough. In one particular embodiment apertures 32 are shown formed in second end wall 26. However, it is clearly to be understood that apertures may be formed in any or each of the walls 20, 22, 24, 26, 28, and 30 as necessary to permit gas to flow into vessel 16 or another component in chamber 12 of housing 10. An access opening 34 with a door 36 may also be formed in one of the walls permitting ingress and egress of a human operator into chamber 12.

As detailed in FIG. 1B, housing 10 includes a housing first section 38 and a housing second section 40. The respective housing sections 38, 40 are configured to be assembled separately and then joined together to create the box-like structure of housing 10. In one particular embodiment, housing first section 38 includes left wall 20, a first section 24A of first end wall 24, a first section 26D of second end wall 26, a first section 28A of top wall 28, and a first section 30A of bottom wall 30. First section 38 is joined to second section 40 along a housing seam union 42. Union seam 42 extends along a longitudinal plane from first end wall 24 to second end wall 26. Housing second section 40 includes right wall 22, a second section 24B of first end wall 24, a second section 26B of second end wall 26, a second section 28B of top wall 28, and a second section 30B of bottom wall 30.

As will be detailed further below, housing 10 is assembled in two sections 38, 40 to permit the stacked vessels 16 to be installed on the floor space 44 of bottom wall 30 within chamber 12 prior to housing 10 being joined and sealed along union seam 42. In one particular embodiment, assembled housing 10 may sit on or be supported by frame 46 to permit safe and sturdy transport of housing 10.

A left side elevation view is detailed in FIG. 2. Left wall 20 extends vertically upwards from frame 46 towards top wall 28. Left wall 20 extends from first wall 24 longitudinally to second wall 26. The longitudinal axis of left wall 20 substantially defines the length of housing 10. Length 48 of housing 10 is long enough to retain two pressure vessels 16 such as particulate separators as understood in the gas processing industry but shorter than any length prescribed as a maximum length for a commercial vehicle by the United States Department of Transportation Federal Highway Administration to permit transportation of the housing without the need for an Oversized Load Shipping Permit.

As detailed in FIG. 3, housing 10 has a width 18 measured laterally from left wall 20 to right wall 22. The housing width 18 being narrower than the maximum allows the transportation of housing 10 without the need for an Oversized Load Shipping Permit. Currently, the United Stated Department of Transportation Federal Highway Administration maximum width for a commercial vehicle is 112 inches. It is contemplated that generally the width 18 of housing 10 will be from about 85 inches to about 102 inches. More particularly in one embodiment, the width 18 of housing 10 is about 96 inches. One exemplary non-limiting advantage of having width 18 be about 96 inches is that it is wide enough to allow a human to enter chamber 12 through door 36 to service vessels 16, but still narrow enough to require vessels 16 to be arranged in a stacked configuration.

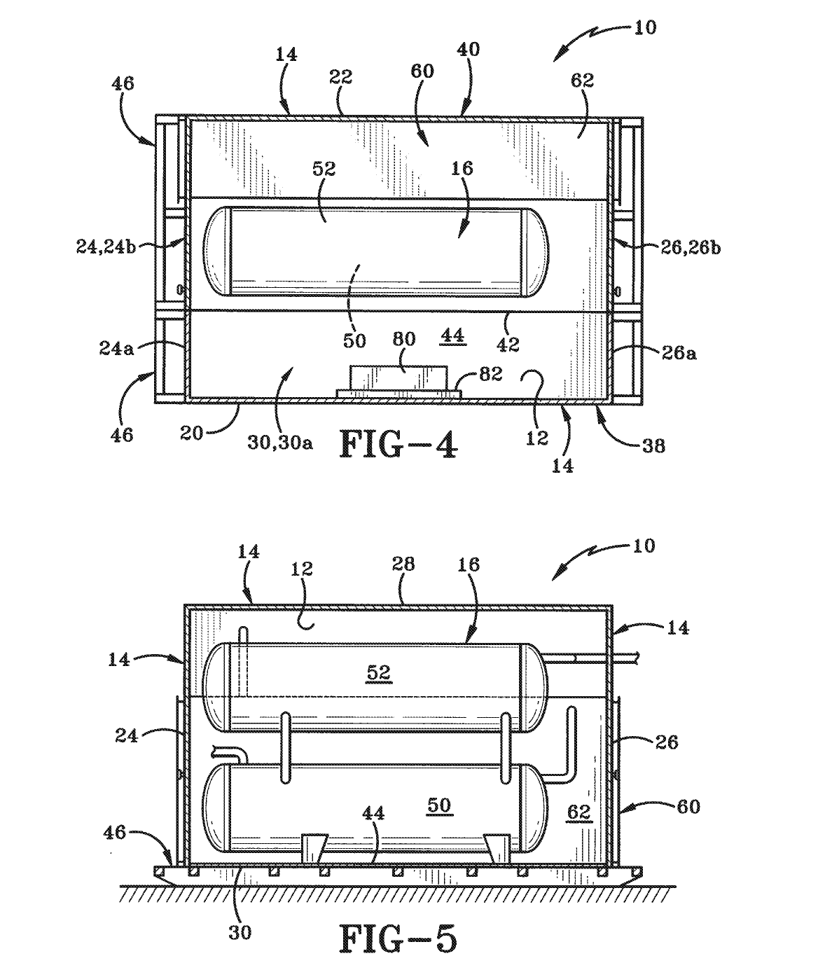

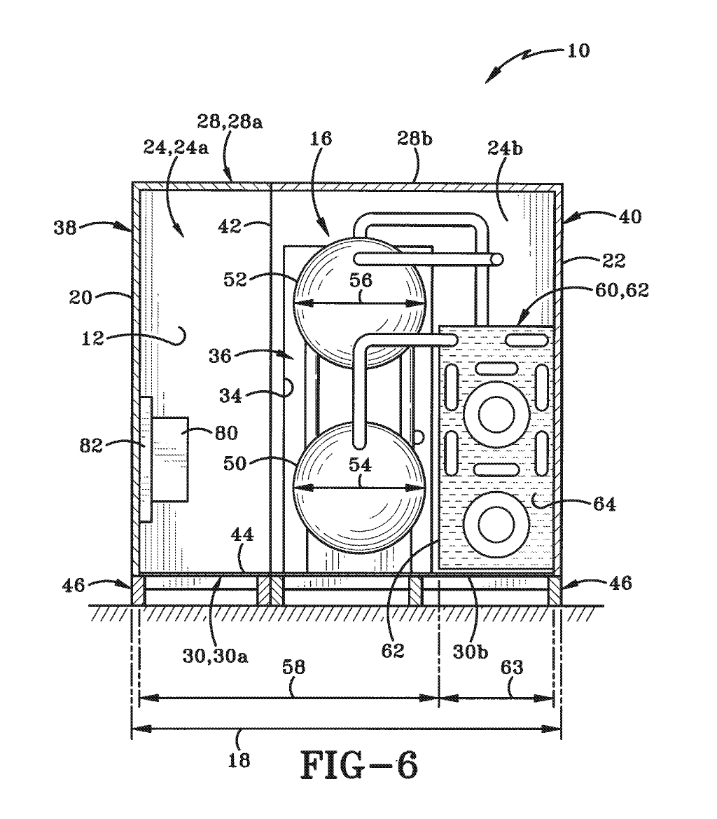

With respect to the section views detailed in FIG. 4, FIG. 5, and FIG. 6, housing 10 houses the pair of pressure vessels 16 in chamber 12. In one particular embodiment, pressure vessels 16 include a first separator 50, and a second separator 52. First and second separators 50, 52 are stacked in a vertical configuration. When viewed from the end, as in FIG. 6, first vessel 50 has a width 54 and second vessel 52 has a width 56. The present invention is configured to house the stacked separators 50, 52 above the floor space 44 having a width 58. Floor width 58 is less than the sum of first and second separator widths 54, 56. Stated otherwise, if separators 50, 52 were arranged in a side-by-side configuration, floor width 58 would be less than the width of the two side-by-side separators 50, 52. Stacked configuration allows housing device to be transported on a conventional tractor-trailer device as overall housing width 18 is less than the Federal Highway maximum as described above. One exemplary stacked pressure vessel 16 is detailed in the patent application filed on equal date herewith in the name of the same inventors and assigned to the same original assignee as this disclosure entitled “STACKED SEPARATORS FOR PROCESSING GAS,” the entirety of which is hereby incorporated by reference as if fully rewritten herein.

With continued reference to FIGS. 4-6, a gas processing heat exchanging unit 60 may also be included within chamber 12 on housing 10. Heat exchanger 60 includes heat exchanging container wall 62 extending from front end 24 extending longitudinally towards and connecting with second end 26. A fluid filled chamber 64 is defined by heat exchanger 60. Chamber 64 includes heat exchanging pipeline extending and winding in a serpentine manner therein to heat fuel moving through pipeline along the flow stream of the gas processing system. Heat exchanger 60 has a width 63 that extends from container wall 62 to left wall 22. Heat exchanger width 63 defines a portion of housing width 18. Further, heat exchanger width 63 plus floor width 58 substantially define housing width 18.

As depicted in FIG. 6, a control system 80 is adjacent one of the housing walls configured to operate the at least two gas processing pressure vessels 16. A mounting bracket 82 connects the control system 80 to an inner surface on one of the housing walls to dispose the control system 80 within the chamber. Control system 80 may include gas processing logic to actuate a valve to send gas through one of the stacked separators 16. “Logic”, as used herein, includes but is not limited to hardware, firmware, software and/or combinations of each and a computer to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

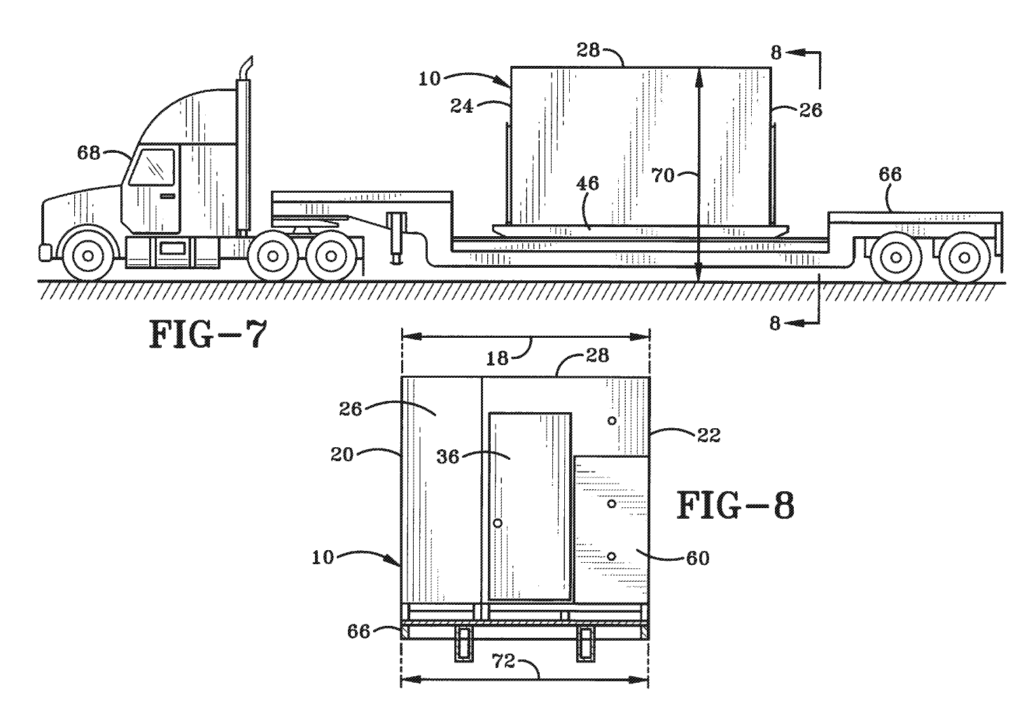

With reference to FIG. 7 and FIG. 8, housing 10 is shown in a transportation environmental side view and cross section end view respectively. Housing 10 is configured to be transported on a trailer 66, towed by tractor-truck or vehicle 68. When housing 10 is on trailer 66 for shipment, the height 70 of the loaded housing 10 on trailer 66 is preferably less than about 14 feet measured from the ground to the top of the housing 10 on trailer 66. One exemplary non-limiting purpose is that, generally heights less than about 14 feet maybe moved along the Federal Highway System. In one particular embodiment, the height of housing 10 itself measured from floor 44 to top wall 28 is from about 100 inches to about 115 inches and even further, in the shown embodiment, housing height from floor 44 to top 28 is 108½ inches. Trailer width 72 is equal to or narrower than the United States Department of Transportation Federal Highway Administration maximum for a commercial vehicle (112 inches at the time of this disclosure). Further, as shown in one particular embodiment (FIG. 8), housing width 18 may be substantially equal or similar to trailer width 72.

In accordance with one aspect of an embodiment of the present invention housing 10 permits a supplier within the oil and gas processing fields to provide a housing for a two separator system that is transportable along the Federal Highways without the need for a special Oversized Load Permit. This is extremely advantageous for shipping costs which ultimately reduces cost to the end consumer.

While it is contemplated that walls 20, 22, 24, 26, 28, and 30 used to construct housing 10 will be constructed from heavy steel ordinarily used in the gas processing housing industry, other materials may suffice to provide adequate security for storing the complex gas processing components contained inside chamber 12.

In operation, housing 10 is constructed by providing first section 38 and second section 40 in pre-assembled form. First section 38 is constructed by welding partial sections 24A, 26A, 28A, and 30A to left wall 20. Second section 40 is constructed by welding partial sections 24B, 26B, 28B, and 30B to right wall 22. First section 38 and section 40 are longitudinally aligned such that their interior chambers are facing each other. With the chambers aligned, the vertically stacked pressure vessels 16 are installed on the floor space 44 in either one of the first section 38 or the second section 40. The two sections 38, 40 are moved laterally inwards in the direction of Arrow(s) A (FIG. 1B) towards each other mating a long union seam.

When the two sections 38, 40 are in a mated position (FIG. 1B), manufacturer welds or otherwise joins sections 38, 40 together along union seam 42. While it is contemplated that the manner in which sections 38, 40 are joined is via weld, clearly other means of coupling section 38, 40 together such as rivets or bolts are entirely possible.

Once the structure of housing 10 has been assembled (FIG. 1B), pipeline may be connected to ensure the pressure vessels or the separators work as designed. In one particular embodiment, first and second separators 50, 52 are aligned and connected via pipeline in a series configuration with the heater being connected via pipeline in series between the two separators 50, 52.

In operation and with respect to transportation/shipment, housing 10 is loaded onto trailer 66 and towed by truck 68 to an end destination. The transporting of the housing on a road is done without the need for an oversized load shipping permit. In one particular embodiment, the end destination is a well site for extracting fossil fuel such as natural gas. As previously discussed, the transport of housing 10 on trailer 66 does not require any special permit because the width 18 of housing 10 is narrower than the federal maximum width for transporting goods via a commercial vehicle on the highway. By way of non-limiting example, this is advantageous as the two vessels 16 are necessary for the gas processing operation occurring at the end destination or the well site.

After transportation and shipment has been completed and housing 10 has been unloaded and placed adjacent a well site, housing 10 operates by processing gas incoming through the inlet and flowing into the first separator 50 where fuel is separated from non-fuels. The fuels may be sent to a downstream pipeline, and the other matter may flow into heater 60 to be heated and then sent via pipeline to second separator 52 where any fuel remaining is separated out a second time and sent to a downstream destination such as a sales pipeline.

Further, when housing is deposited at a site location an operator may enter the chamber through the door formed in a sidewall of the housing. The operator may then contact a component on a control system to actuate an element along a pipeline to manipulate gas in the pipeline. Alternatively, after depositing the housing having the stacked pressure vessels therein at a site location, an element may be actuated along a pipeline in communication with the two pressure vessels remotely via a control system 80 mounted to the housing.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the invention are an example and the invention is not limited to the exact details shown or described.

What is claimed:

1. A transportable housing for a gas processing apparatus comprising:
a housing including a plurality of housing walls joined together defining a chamber therein retain at least two gas processing pressure vessels in a vertically stacked configuration; and
a housing width distance on the housing narrower than the United States Department of Transportation Federal Highway Administration maximum width for a commercial vehicle to allow transportation of the housing without the need for an oversized load shipping permit.

2. The housing of claim 1, wherein the housing width is from about 85 inches to about 102 inches.

3. The housing of claim 1, further comprising:
a floor width defining a portion of the housing width, the floor width less than the sum of the two gas processing pressure vessel widths.

4. The housing of claim 3, wherein the at least two gas processing pressure vessels are positioned above the floor width.

5. The housing of claim 1, further comprising:
a control system adjacent one of the housing walls configured to operate the at least two gas processing pressure vessels.

6. The housing of claim 5, further comprising:
a mounting bracket connecting the control system to an inner surface on one of the housing walls to dispose the control system within the chamber.

7. The housing of claim 1, further comprising:
a fluid filled container positioned inside the chamber configured to retain heat exchanging pipeline submerged in the fluid.

8. The housing of claim 4, further comprising:
a first container wall on the fluid filled container extending from a front housing wall to a rear housing wall.

9. The housing of claim 1, further comprising:
at least two connectable sections respectively forming left and right housing sections, the sections defining a portion of the chamber when connected.

10. The housing of claim 1, further comprising:
an access door in one of the plurality of housing walls to permit ingress and egress with the chamber.

11. The housing of claim 1, further comprising:
a housing sidewall defining an aperture permitting gas to flow therethrough into the chamber towards one of the pressure vessels in a pipeline.

12. The housing of claim 1, in combination with a tractor and towed trailer wherein the transportable housing for a gas processing apparatus is supported on the trailer, the combination comprising:
a height less than about 14 feet measured from the ground to the top of the housing on the trailer.

13. The housing of claim 1, in combination with a tractor and towed trailer wherein the transportable housing for a gas processing apparatus is supported on the trailer, the combination comprising:
a trailer width generally equal to the housing width.

14. A housing for two vertically stacked fuel separators comprising:
a first sidewall on a housing box therein defining a chamber;
a second sidewall on the housing box spaced apart from the first sidewall;
a housing width distance, defined from the first sidewall to the second sidewall, less than about 102 inches;
the chamber adapted to therein contain two vertically stacked gas processing separators and a gas processing heater; and
a heat exchanging container within the chamber.

15. The housing of claim 11, further comprising:
a floor on the housing box;
a footprint area on the floor, the footprint area generally equal to the length multiplied by the width of a single separator; and
two vertically stacked gas processing separators mounted to the housing box above the footprint area.

16. The housing of claim 11, further comprising:
a floor width defining a portion of the housing width;
a heat exchanger width defining a separate portion of the housing width; and
wherein the floor width is less than the sum of the two separator widths.

17. The housing of claim 11, further comprising:
a first segment of the housing box defining the first sidewall;
a second segment of the housing box defining the second sidewall and distinct from the first housing segment; and
wherein the first and second housing segments are connectable to form the housing box.

18. A method of use for two gas processing pressure vessels comprising the steps of:
mounting two gas processing pressure vessels in a stacked configuration within a chamber of a gas processing housing; and
attaching a wall to the housing to enclose the chamber, wherein the housing includes a housing width narrower than the United States Department of Transportation Federal Highway Administration maximum width for a commercial vehicle to allow transportation of the housing without the need for an oversized load shipping permit.

19. The method of claim 18, further comprising the steps of:
transporting the housing on a road without the need for an oversized load shipping permit.

20. The method of claim 19, further comprising the steps of:
depositing the housing having the stacked pressure vessels therein at a site location; and
entering the chamber through a door formed in a sidewall of the housing.

21. The method of claim 20, further comprising the steps of;
contacting a component on a control system to actuate an element along a pipeline to manipulate gas in the pipeline.

22. The method of claim 19, further comprising the steps of:
depositing the housing having the stacked pressure vessels therein at a site location; and
actuating an element along a pipeline in communication with the two pressure vessels remotely via a control system mounted to the housing.

23. A gas processing apparatus housing comprising:
a floor defining a width;
a set of housing walls connected to the floor defining a chamber therein, the chamber adapted to retain a pair of gas processing pressure vessels in a vertically stacked configuration; and
the floor width inside the chamber is less than a width for said pair of pressure vessels if said vessels were in a side-by-side configuration.
